(19) United States
(12) Patent Application Publication
(10) Pub. No.: US 2002/0095313 A1
(43) Pub. Date: Jul. 18, 2002

(54) Computer system for assisting a physician

(76) Inventor: Mohamed M. Haq, Friendswood, TX (US)

Correspondence Address: Howard L. Speight, Two Memorial City Plaza, Suite 1360, 820 Gessner, Houston, TX, 77024, US

(21) Appl. No.: 09/760,917

(22) Filed: Jan. 16, 2001

Related U.S. Application Data
(60) Provisional application No. 60/236,930, filed on Sep. 28, 2000.

(51) Int. Cl. G06F 17/60

(52) U.S. Cl. 705/2

(57) ABSTRACT

A computer system for assisting a physician is disclosed. The computer system includes a computer processor means for processing data and a data storage means for storing data on a storage medium. The computer system includes a first means for processing data regarding a patient, a diagnosis regarding the patient, and a treatment plan for the patient and for using such data to (a) generate alarms if the diagnosis or treatment plan is inappropriate and to (b) provide advice regarding the diagnosis and treatment plan. The computer system also includes a second means for processing data regarding the alarms and advice and for using such data to communicate the alarms and advice to the physician. The computer system also includes a third means for processing data regarding the treatment plan and using such data to implement the treatment plan. The computer system also includes a fourth means for processing data regarding the patient, the diagnosis regarding the patient, and the treatment plan, and storing such data on the data storage means.

### FIELD of the INVENTION

This application claims the benefit of U.S. Provisional Patent Application Serial No. 60/236930, filed on Sept. 28, 2000.

The invention relates generally to the field of applying computers to the practice of medicine. More particularly, the invention relates to the field of reducing the likelihood of error in the practice of medicine and elevating the standard of care provided by an average physician to that of an expert in the field.

### BACKGROUND OF THE INVENTION

The practice of medicine by a physician requires obtaining history from the patients, performing a physical examination, ordering laboratory and radiological tests, interpreting the results, and ordering medication to treat the disorder diagnosed. Three out of four office visits to a doctor in the United States result in a prescription (New York Times, Sep. 5, 2000 D8) and all patients admitted to the hospital have orders written by doctors.

While physicians are highly trained individuals, they rely on their educational background, training, accumulated knowledge base, experience and memory to make complex treatment decisions for the patients. They have diverse educational backgrounds (e.g. graduates of Harvard or Stanford Medical Schools to graduates of rural medical schools or foreign medical schools), varied age groups (e.g. newly trained physicians educated with the latest advances in medicine to older physicians trained many years ago), they work long hours where mental and physical fatigue could decrease their ability to think clearly and prescribe the best medicines.

Further, the knowledge base in medicine is expanding so rapidly that it has become virtually impossible for any single physician to remember all of it even in a very narrow specialty. Compounding these difficulties are logistical problems of laboratory and radiology results being conveyed to the physician or the physician's surrogate. There is a significant time lapse between the time the tests are performed and the time the physician actually sees the results. Once the laboratory tests are ordered, the results typically are mailed to the physician the next day and, depending on the physician's schedule, the results may not be used for treatment decisions in the most timely manner possible.

Moreover, when medications are prescribed, physicians are not always aware of adverse interactions with other medicines or certain foods the patient may be fond of eating. A patient may be seeing multiple physicians and taking medications prescribed by each of them. There may be little communication between the physicians and patients may forget to inform one physician that they are also seeing other physicians and receiving other medications. Consequently, a patient may receive prescriptions from two different doctors that interact with each other. For example, if a patient with a heart condition takes an antacid (a medication for indigestion and heartburn), which is commonly available over the counter, together with Digoxin (a drug used in treatment of heart failure), the dose absorbed of Digoxin may be reduced by 25 percent, potentially leading to complications of the patient's heart condition.

The factors just described may lead to poor patient outcomes, delayed or improper diagnosis, delay in treatment, adverse drug interactions, adverse drug and food interactions, and delays in adjusting or changing medications based on abnormal lab results. This makes the practice of medicine sub-optimal, expensive, and at times dangerous, causing an estimated 44,000 to 98,000 deaths every year (Institute of Medicine, A Branch of National Academies, Report November 1999, http://www4.nationalacademies.org). President Clinton in a Rose Garden ceremony on Dec. 7, 1999, commenting on The Institute of Medicine's report, stated that up to 7,000 people die because of errors in prescribing medicine. He estimated the cost of all these errors to add as much as $29 billion to our medical bills. Even though there are numerous publications and conferences held to assist physicians in overcoming these problems, most physicians are unable to extract unbiased information for practice of rational therapeutics. (Wooseley R. L. Centers for Education and Research in Therapeutics-Clinical Pharmacology and Therapeutics 1994:55:249:255) A recently published study suggests that changes in the processes and not in people were most likely to be successful. They recommend the use of protocols and checklists (Reducing Adverse Drug Events; Journal on Quality Improvement, Vol. 26, Number 6, Page 321, June 2000).

### SUMMARY of the INVENTION

The availability of computers and wireless technologies make it possible to minimize the problems described above. A system is disclosed for assisting every physician in prescribing the best possible treatment. Analogous to spell check and grammar check in word processors, the system detects errors in prescriptions, and orders written on hospitalized patients, and provides the physician with appropriate choices. Additionally, the system makes available to the physician, for each defined disease category whenever available, the treatment selected by a panel of experts.

The system disclosed below approaches the above mentioned problems by helping a physician use a laptop computer, a personal digital assistant (PDA), or a desktop computer to generate all prescriptions and orders with a built in error correction system. It also includes several other real time features to make an average community physician function like an expert at all times, day or night without fatigue and human error. It will also be up to date with the latest information.

In general, in one aspect, the invention features a computer system for assisting a physician. The computer system includes a computer processor means for processing data and a data storage means for storing data on a storage medium. The computer system includes a first means for processing data regarding a patient, a diagnosis regarding the patient, and a treatment plan for the patient and for using such data to (a) generate alarms if the diagnosis or treatment plan is inappropriate and to (b) provide advice regarding the diagnosis and treatment plan. The computer system also includes a second means for processing data regarding the alarms and advice and for using such data to communicate the alarms and advice to the physician. The computer system also includes a third means for processing data regarding the treatment plan and using such data to implement the treatment plan. The computer system also includes a fourth means for processing data regarding the patient, the diagnosis regarding the patient, and the treatment plan, and storing such data on the data storage means.

Implementations of the invention may include one or more of the following. The first means for processing data may include a suggest diagnosis means for processing data using a subset of the patient data to access a suggested diagnosis database to retrieve a suggested diagnosis. The first means for processing data may include a check diagnosis means for processing data for comparing the diagnosis to the suggested diagnosis and for generating an alarm if there is a substantial difference. The first means for processing data may include a find standard diagnostic criteria means for processing data using a subset of the diagnosis to access a standard diagnosis criteria database to produce a standard diagnosis criteria.

The treatment plan may include a prescription. The first means for processing data may include a get drug data means for processing data using a subset of the patient data to retrieve from a pharmacy the drugs prescribed for the patient and from the data storage means an identification of other drugs that the patient is taking. The first means for processing data may include an interaction checking means for processing data to access a drug interaction database with (a) the drugs prescribed for the patient, (b) the other drugs that the patient is taking, and (c) the prescription, to produce an alarm if there is an indication of an interaction. The interaction checking means may include mitigating means for suggesting methods to mitigate the interaction and alternative recommendation means for suggesting alternative drugs with no interaction.

The first means for processing data may include a get patient data means for processing data for accessing the data storage means to retrieve stored data regarding the patient and a find treatment means for processing data for accessing a treatment protocol database using a subset of the patient data and a subset of the stored patient data to retrieve a recommended treatment protocol. The first means for processing data may include a treatment search means for processing data for accessing a treatment recommendation database using a subset of the patient data and a subset of the stored patient data to retrieve a treatment individualization recommendation.

The first means for processing data may include a get lab data means for processing data using a subset of the patient data to acquire laboratory results from a laboratory and a find dosage means for processing data for using the lab results, a subset of the patient data, the prescription and data regarding the patient stored on the data storage means to access a recommended dosage database to produce a recommended dosage for the prescription.

The patient data may include foods the patient eats. The first means for processing data may include an interaction checking means for processing data to access a drug/food interaction database with (a) the drugs prescribed for the patient, (b) the other drugs that the patient is taking, (c) the prescription and (d) the foods the patient eats, to produce an alarm if there is an indication of an interaction. The interaction checking means may include a recommendation means for recommending a drug that will not have an interaction.

The treatment plan may include radiology tests. The first means for processing data may include an X-ray compatibility checking means for processing data to access a radiology/drug interaction database with (a) the drugs prescribed for the patient, (b) the other drugs that the patient is taking, (c) the prescription and (d) the radiology tests from the treatment plan, to produce an alarm if there is an indication of an interaction.

The treatment plan may include an order for X-rays. The first means for processing data may include a check X-rays means for processing data using a subset of the patient data to acquire laboratory results from a laboratory and for accessing an X-ray contraindication database with the laboratory results and the order for X-rays to produce a contraindication and to process the contraindication to produce an alarm. The check X-rays means for processing data may process the contraindication to produce a recommendation.

The first means for processing data may include a drug cost means for processing data to access a drug cost database with (a) the drugs prescribed for the patient, (b) the other drugs that the patient is taking, and (c) the prescription, to produce an alarm if there is an indication that the patient is spending more on drugs than is necessary and to make a recommendation for a lower cost drug.

The first means for processing data may include a check risks means for processing data using a subset of the patient data to access a risk data base to produce a risk reduction recommendation for the patient.

The computer system may include a fifth means for processing data through which a patient has access to data regarding the patient stored on the storage means. The patient may have access to the first means.

The third means may include a personal communicator. The personal communicator may include a personal digital assistant or a personal computer. The personal communicator may include a PC database for storing patient data. The PC database may be protected by a first security system. The data storage means may be protected by a second security system.

The personal communicator may include a display. The display may include a red alert area, where alarms regarding the potential for a major adverse effect are displayed. The display may include a yellow alert area, where alarms regarding the potential for a minor effect or need for closer monitoring are displayed.

The third means may communicate with the computer processor means through a communications media. The communications media may be a wireless communications media. The wireless communications media may include one or more of the following types of media: RF, optical or infrared. The communications media may be a wired communications media. The wired communications media may include one or more of the following types of media: twisted pair cable, coax cable, or optical cable.

The data stored on the data storage means may include one or more of the following: a suggested diagnosis database; a standard diagnostic criteria database; a drug interaction database; a treatment protocol database; a treatment recommendation database; a recommended dosage database; a radiology/drug interaction database; an X-ray contraindication database; a drug cost database; and a risk database.

The first means may have access to one or more of the following via the Internet: a suggested diagnosis database; a standard diagnostic criteria database; a drug interaction database; a treatment protocol database; a treatment recommendation database; a recommended dosage database; a radiology/drug interaction database; an X-ray contraindication database; a drug cost database; and a risk database.

The third means may include an ICD determination means for processing a subset of the patient data, a subset of the diagnosis and a subset of the treatment plan to determine an ICD. The patient data may include an ICD, and the third means may include one or more of the following: a print prescription means for processing data for using the prescription to print a prescription form; an inform pharmacy means for processing data for using the prescription to inform a pharmacy of the prescription; a store data means for processing data to store patient data on a hospital computer; an enter order means for processing data to enter the order in a physician order entry system; and a save ICD means for processing data to save the ICD in a business office.

In general, in another aspect, the invention features a computerized method for providing assistance to a physician who has gathered data from a patient, made a diagnosis, and prepared a treatment plan. The treatment plan includes one or more of the following: (a) a prescription, (b) radiology tests, (c) X-rays, and (d) a treatment protocol. The method is accomplished using a personal communicator, a computer processor coupled to the personal communicator through a communications media, a data storage media coupled to the computer processor, and Internet resources coupled to the computer processor. The method includes entering patient data, a diagnosis and a treatment plan into the personal communicator. The method further includes selecting, through the personal communicator, one or more of the following actions: implementing the treatment plan; consulting resources to produce an alarm and a recommendation; displaying the alarm and the recommendation; and allowing the physician to revise the diagnosis and treatment plan based on the alarm and the recommendation.

Implementations of the invention may include one or more of the following. Implementing the treatment plan may include one or more of printing a prescription, informing a pharmacy of the prescription, storing the patient data, the diagnosis, and the treatment plan on a hospital computer, entering an order into a physician order entry system, and saving an ICD in a business office. Consulting resources to produce an alarm and a recommendation may include offering the physician consultation choices, communicating a subset of the patient data, the diagnosis, the treatment plan and the consultation choice to the computer processor, processing the patient data, the diagnosis and the treatment plan in accordance with the consultation choice to produce alarms and advice, and communicating the alarms and advice to the personal communicator. Processing the patient data, the diagnosis and the treatment plan in accordance with the consultation choice to produce alarms and advice may include performing one or more of the following actions: checking the accuracy of the diagnosis, reviewing standard diagnostic criteria, checking the appropriateness of prescribed medication, reviewing recommended treatment protocols, reviewing individualization recommendations, recommending dose adjustments, checking for adverse medication interactions, checking for adverse food interactions, checking for adverse medication/radiology interactions, checking for X-ray contraindications, checking the cost of prescribed medications, transferring clinical notes to medical records, reviewing standard immunization protocols, and recommending routine screening measures.

The method may further include accepting clinical notes regarding the patient. Accepting the clinical notes may include recording a spoken rendering of the clinical notes.

### BRIEF DESCRIPTION of the DRAWINGS

FIG. 1 is a flow chart describing the processing performed by the computer system for assisting a physician.

FIG. 2 is a flow chart of the consult resources process.

FIG. 3 is a flow chart of the offer consultation choices process.

FIG. 4 is a block diagram of the computer system for assisting a physician.

FIG. 5 is a data flow diagram of the computer system for assisting a physician.

FIG. 6 is a data flow diagram for a portion of the analyze data process.

FIG. 7 is a data flow diagram for a portion of the analyze data process.

FIG. 8 is a data flow diagram for a portion of the analyze data process.

FIG. 9 is a data flow diagram for a portion of the analyze data process.

FIG. 10 is a data flow diagram for a portion of the analyze data process.

FIG. 11 is a data flow diagram for a portion of the analyze data process.

FIG. 12 is a data flow diagram for a portion of the analyze data process.

FIG. 13 is a data flow diagram for a portion of the analyze data process.

FIG. 14 is a data flow diagram for a portion of the analyze data process.

FIG. 15 is a data flow diagram for a portion of the analyze data process.

FIG. 16 is a data flow diagram for a portion of the analyze data process.

FIG. 17 is a data flow diagram showing the ability of a patient to access data on the system.

FIG. 18 is a data flow diagram showing patient access to the system's data and processes.

FIG. 19 is a data flow diagram showing patient access to the system's data and processes.

FIG. 20 is a data flow diagram showing patient access to the system's data and processes.

FIG. 21 is a data flow diagram showing patient access to the system's data and processes.

FIG. 22 is a data flow diagram showing patient access to the system's data and processes.

FIG. 23 shows security systems surrounding databases in the system.

FIG. 24 illustrates a personal communicator.

### DESCRIPTION of the PREFERRED EMBODIMENTS

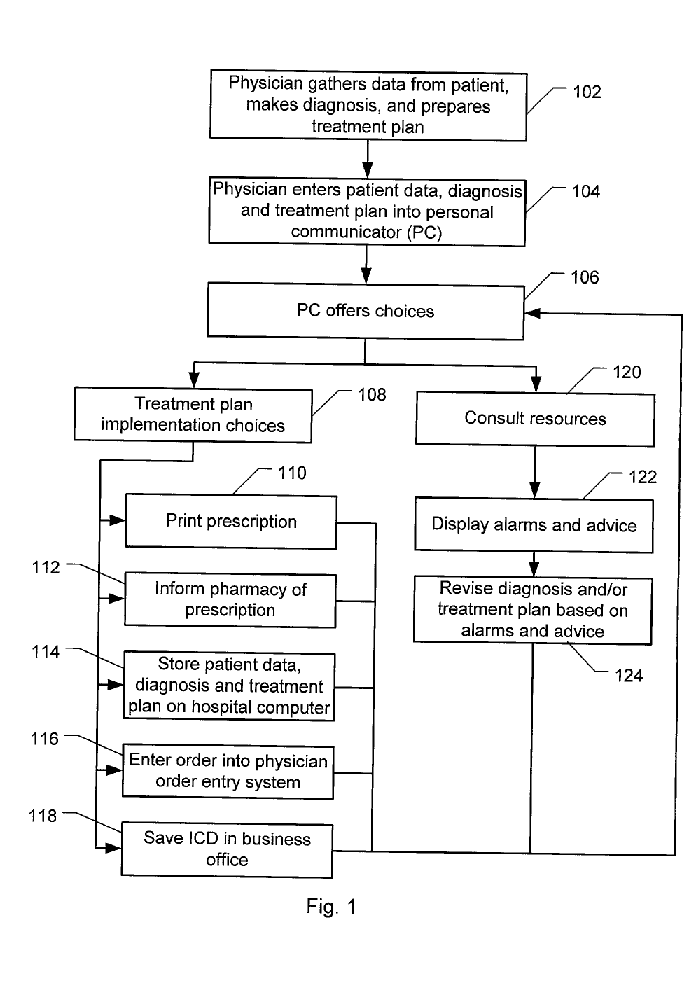

A computerized method for providing assistance to a physician, illustrated in FIG. 1, begins with the physician gathering data from a patient, making a diagnosis, and preparing a treatment plan (block 102). The treatment plan includes one or more of the following: (a) a prescription, (b) orders for laboratory and radiology tests, and (c) a treatment protocol.

The method is accomplished using a personal communicator, which can be a laptop computer, a PDA, a desktop computer, a properly-equipped cellular phone, or any other device capable of providing the functions described below. A computer processor is coupled to the personal communicator through a communications media. A data storage media is coupled to the computer processor. Internet resources are coupled to the computer processor.

In the next step, the physician enters patient data, a diagnosis and a treatment plan into the personal communicator (block 104). The physician then selects, through the personal communicator, one or more actions (block 106). One action the physician can request is that the treatment plan be implemented (108). Implementing the treatment plan may involve a number of actions. If the treatment plan includes a prescription, the system will, at the request of the physician, print the prescription on a printer in the physician's office or on another nearby printer (block 110). The resulting prescription form will be free of problems associated with the physician's penmanship and less likely to be misinterpreted by a pharmacy.

The physician can also choose, through a selection made on the personal communicator, to directly inform a pharmacy of the prescription (block 112), thereby reducing the likelihood of error and increasing the speed of the process.

The physician can also request that the patient data, diagnosis and treatment plan be stored on a hospital computer (block 114), if the patient is in the hospital. Such an action would make the information available for later consultation by the physician that entered the data, by other physicians, by other members of the hospital staff, or by the patient.

The physician can also request that any orders that are included in the treatment plan be entered into the hospital's order entry system (block 116), if one is available and the physician has the necessary clearance and access.

The physician can also request that the personal communicator determine the proper ICD (International Classifications of Diseases) code and a billing code for the diagnosis and save one or both codes in the business office (block 118) to allow the business office to properly bill for the physician's work. In a preferred embodiment, the personal communicator includes an ICD determination process that processes a subset of the patient data, a subset of the diagnosis and a subset of the treatment plan to determine an ICD.

Another action the physician can request is to consult resources made available to the physician through the system (block 120). Using this facility, the physician can double-check his or her diagnosis and treatment plan against all of the information that has been collected and stored regarding the patient and a variety of resources made available through the system and through the Internet, as described in more detail below. Consulting the resources may produce an alarm and advice. If so, the system displays the alarm and the advice (block 122), and allows the physician to revise the diagnosis and treatment plan based on the alarm and the recommendation (block 124).

Alternatively, the physician may enter only the patient data at block 120 and ask the system to suggest a diagnosis and treatment plan. In that case, the advice returned by the system at block 122 is a suggested diagnosis and treatment plan.

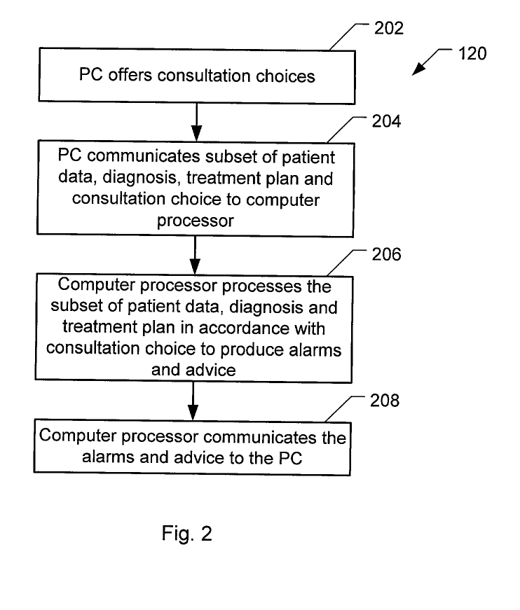

The action of consulting resources to produce an alarm and advice, illustrated in more detail in FIG. 2, begins with the personal communicator offering the physician consultation choices, as discussed below (block 202). The personal communicator communicates a subset of the patient data, the diagnosis, the treatment plan and the consultation choice to the computer processor (block 204). The computer processor processes the patient data, the diagnosis and the treatment plan in accordance with the consultation choice to produce alarms and advice (block 206). The computer processor then communicates the alarms and advice to the personal communicator (block 208), where they are displayed to the doctor.

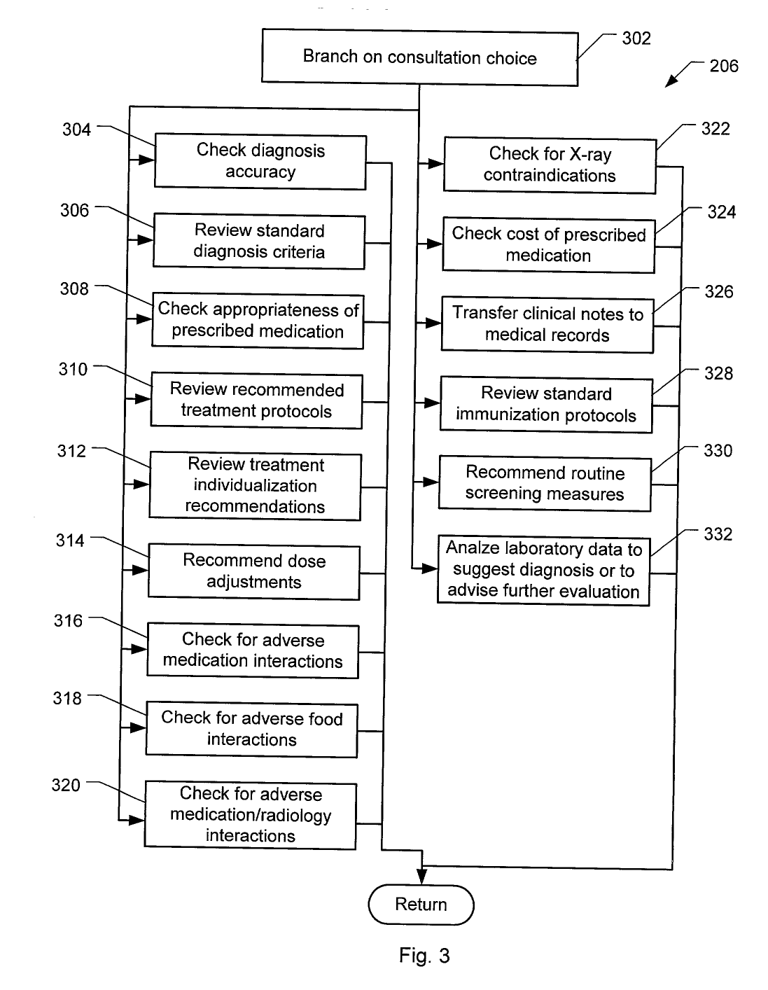

The consultation choices (block 302), illustrated in FIG. 3, provided by the personal communicator include at least the following:

checking the accuracy of the diagnosis (304);

reviewing standard diagnostic criteria (306);

checking the appropriateness of prescribed medication (308);

reviewing recommended treatment protocols (310);

reviewing individualization recommendations (312);

recommending dose adjustments (314);

checking for adverse medication interactions (316);

checking for adverse food interactions (318)

checking for adverse medication/radiology interactions (320);

checking for X-ray contraindications (322);

checking the cost of prescribed medications (324);

transferring clinical notes to medical records (326);

reviewing standard immunization protocols (328);

recommending routine screening measures (330); and

analyzing laboratory data to suggest a diagnosis or to advise further evaluation.

The system may accept clinical notes regarding the patient. The clinical notes may be in handwriting or other written form (in which case they may be scanned for electronic storage), in electronic form (entered using a keyboard, mouse, stylus, or other data entry device), or through voice recording or voice recognition.

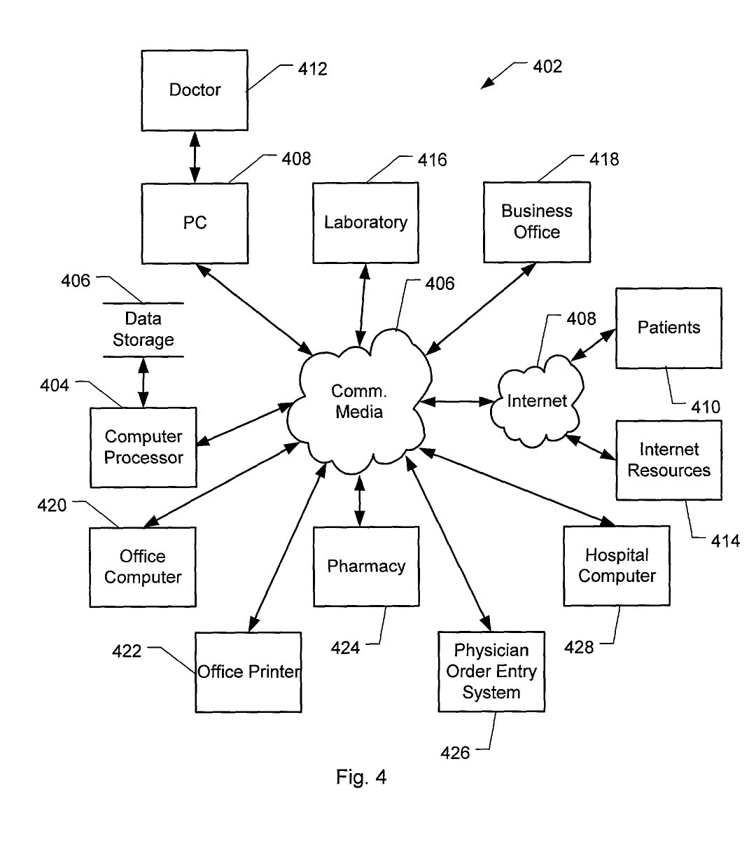

A computer system for assisting a physician 402, illustrated as a block diagram in FIG. 4, includes a computer processor 404 for processing data and a data storage 404 for storing data on a storage medium, such as a disk drive, an optical disk, or any other storage medium known in the art. A personal communicator 408 is coupled to the computer processor 404 through a communications media 406, which may be hardwired (i.e. copper wire, coaxial cable or optical cable) or wireless (using such technology as cellular communication or Bluetooth). The communications medium 406 also provides a portal to the Internet 408 through which patients 410 can access controlled portions of the data storage 406 and through which a physician 412 and the system 402 can access resources 414 available on the Internet.

The system 402 provides interconnection through the communications media 406 for a variety of elements of a hospital or physician's office, including a laboratory 416, a business office 418, an office computer 420, an office printer 422, a pharmacy 424, a physician order entry system 426 and a hospital computer 428. The hospital computer may incorporate the computer processor 404 and the data storage 406.

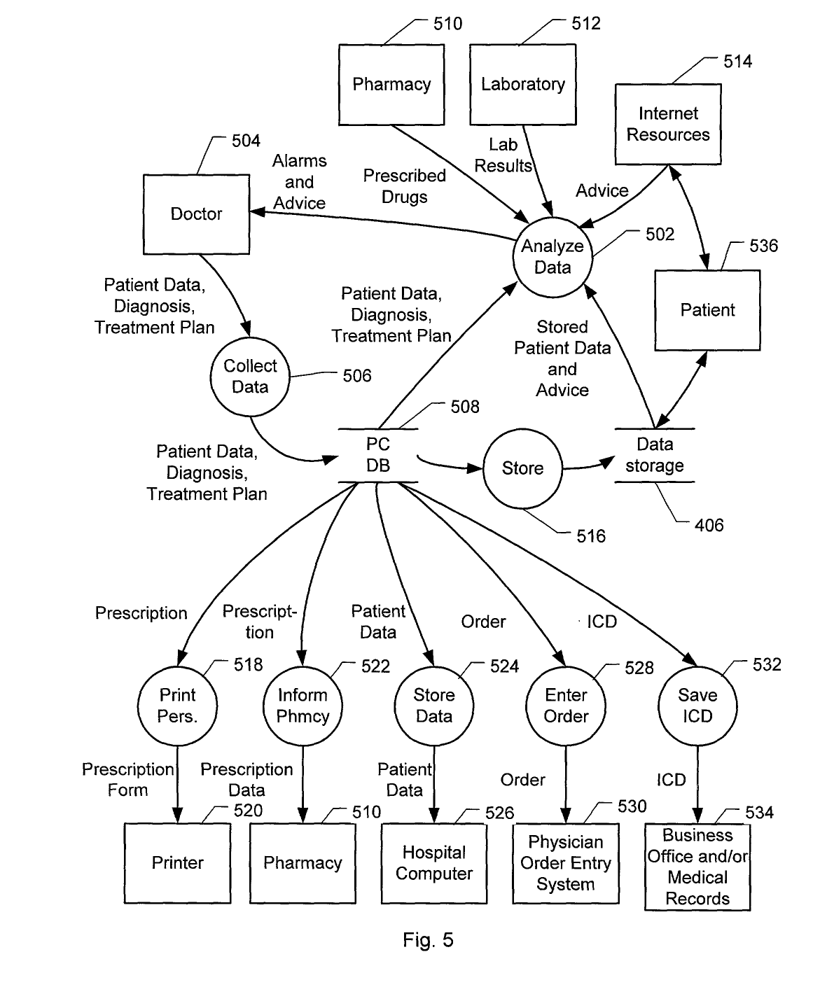

The system, illustrated as a data flow diagram in FIG. 5, provides an analyze data process 502 to analyze the data collected by a doctor 504 regarding a patient, a diagnosis regarding the patient, and a treatment plan for the patient. The doctor 504 collects the data regarding the patient in a collect data process 506 and enters it into the personal communicator, where it is stored in a PC database 508. The doctor also develops a diagnosis and a treatment plan which are also entered into the personal communicator and stored in the PC database 508.

The analyze data process 502 generates alarms if the diagnosis or treatment plan is inappropriate and provides advice, through the personal communicator, regarding the diagnosis and treatment plan. To provide this function, the analyze data process 502 receives inputs from the pharmacy 510, including a list of drugs that have been prescribed for the patient, and the laboratory 512, including laboratory results for the patient. The analyze data process 502 also receives advice from the data storage 406 and Internet resources 514 based on the patient data stored in the PC database 508 and stored patient data stored in the data storage 406.

The system also includes data processing for communicating the alarms and advice produced by the analyze data process 502 to the doctor 504. In a preferred embodiment, this process resides on the personal communicator.

The system also provides data processing to implement the treatment plan and data processing 516 to store such data on the data storage 406.

The data processing to implement the treatment plan includes:

(a) print data processing 518 to print a prescription form on a printer 520;

(b) inform pharmacy data processing 522 to inform the pharmacy 510 of the prescription;

(c) store data processing 524 to store patient data on a hospital computer 526 (which may be the same as the data storage 406);

(d) enter order data processing 528 to enter an order in a physician order entry system 530;

(e) save ICD data processing 532 to save the ICD in a business office or in a medical records facility 534.

The analyze data process 502 provides a number of capabilities to support and verify the actions recommended and taken by the doctor. The system analyzes the diagnosis and treatment plan prepared by the doctor against a number of standards and provides alarms if those standards are not met and recommendations for meeting the standards. The following discussion illustrates the examples of the types of analysis that can be done by the system. The purpose of the analysis is to lessen the likelihood that the doctor will take an action that will harm the patient or cost the patient more than is necessary.

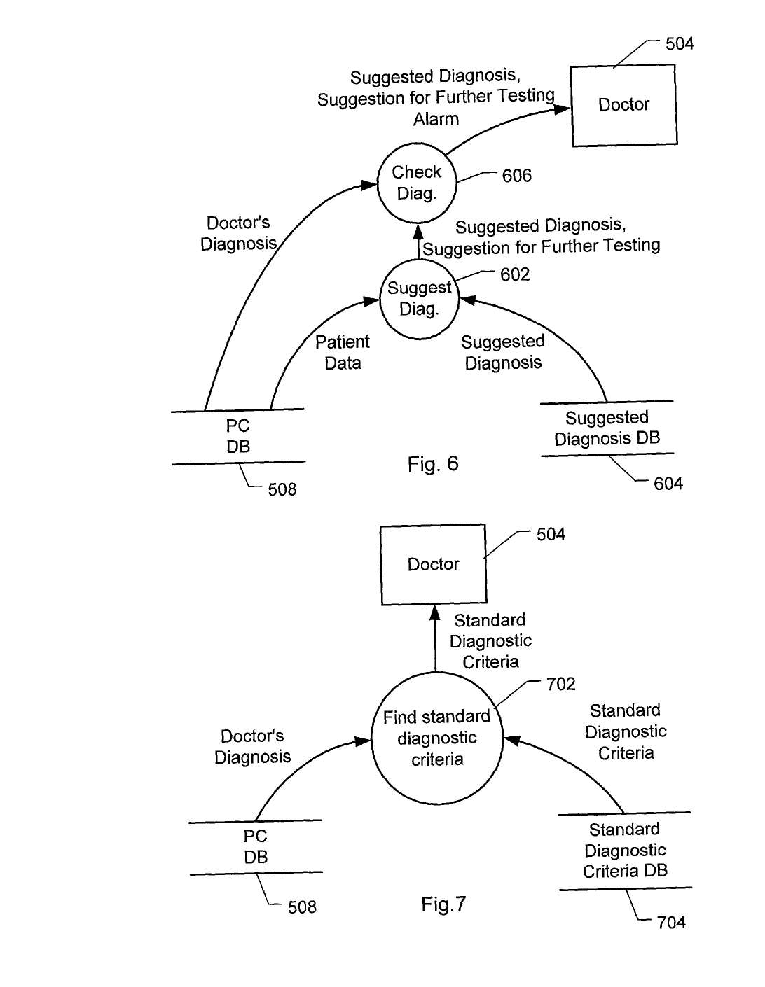

As a first example, illustrated in FIG. 6, the analyze data process includes a suggest diagnosis process 602 to access a suggested diagnosis database 604 using the patient data to retrieve a suggested diagnosis or suggestion for further testing. For example, a blood test result showing anemia may result in a suggestion for a diagnosis of iron deficiency or it may indicate the need for additional evaluation for other possible diagnoses, such as bone marrow failure. A check diagnosis process 606 compares the doctor's diagnosis retrieved from the PC database 508 with the suggested diagnosis and generates an alarm if there is a substantial difference.

As another example, illustrated in FIG. 7, the analyze data process includes a find standard diagnostic criteria process 702 that uses a subset of the doctor's diagnosis from the PC database 508 to access a standard diagnosis criteria database 704 to produce standard diagnosis criteria. The standard diagnosis criteria database 704 (which may be one database or a set of databases) preferably includes established criteria for making a diagnosis of various diseases as determined by an expert panel. For example, diagnosis of congestive heart failure requires two major or one major and two minor Framingham criteria and diagnosis of rheumatoid arthritis requires at least four of the seven American Rheumatism Association criteria. This information would be available to the doctor through a few simple commands on the personal communicator.

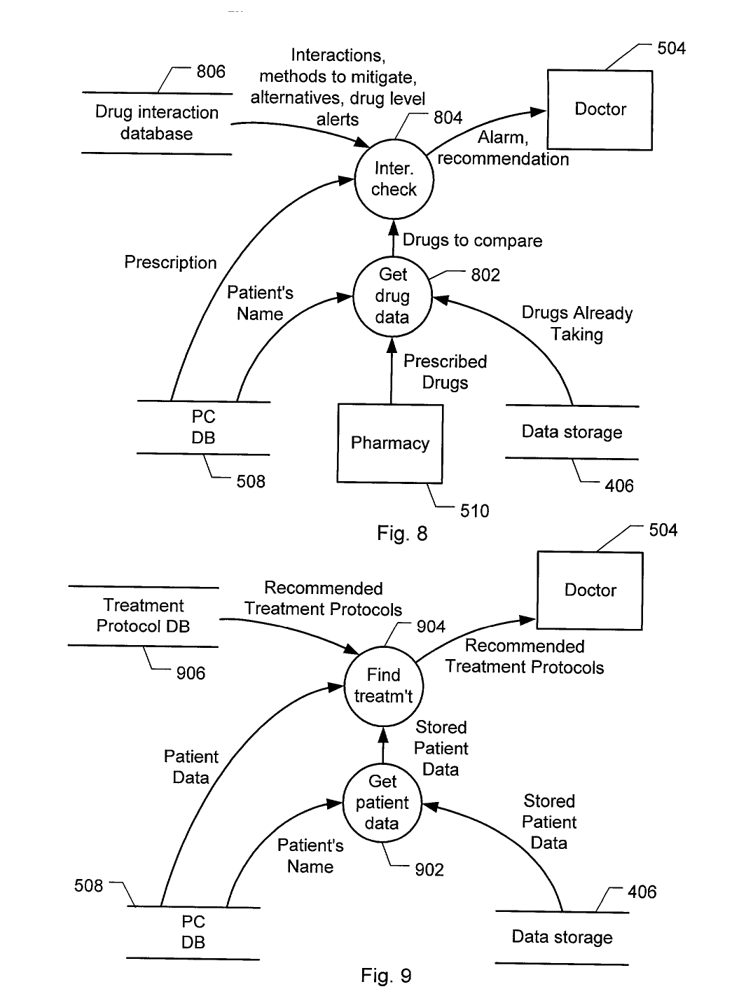

As another example, illustrated in FIG. 8, the analyze data process includes a get drug data process 802 which uses a subset of the patient data to retrieve from the pharmacy 510 the drugs prescribed for the patient and from the data storage 406 an identification of other drugs that the patient is taking. An interaction checking process 804 accesses a drug interaction database 806 with (a) the drugs prescribed for the patient, (b) the other drugs that the patient is taking, and (c) the prescription, to produce an alarm if there is an indication of an interaction. Further, the interaction checking process 804 produces an alarm if the patient is taking a drug which requires periodic monitoring of the level of the drug in the blood stream and the period for monitoring has expired. The interaction checking process 804 also includes a mitigating process that suggests methods to mitigate the interaction and an alternative recommendation process for suggesting alternative drugs with no interaction.

As another example, illustrated in FIG. 9, the analyze data process includes a get patient data process 902 that accesses the data storage 406 to retrieve stored data regarding the patient using the patient's name as a key. A find treatment process 904 accesses a treatment protocol database 906 using a subset of the patient data and a subset of the stored patient data to retrieve a recommended treatment protocol. The treatment protocol database 906 may contain detailed treatment protocols for various diseases with adjustments to be made on basis of patient tolerance and response. For example, the treatment protocol database 906 may contain the National Comprehensive Cancer Network guidelines for various cancers. Further, the treatment protocol database 906 may contain treatment guidelines issued by various sub-specialty societies for treatment of various diseases. The treatment protocol database 906 may be a single database or multiple databases.

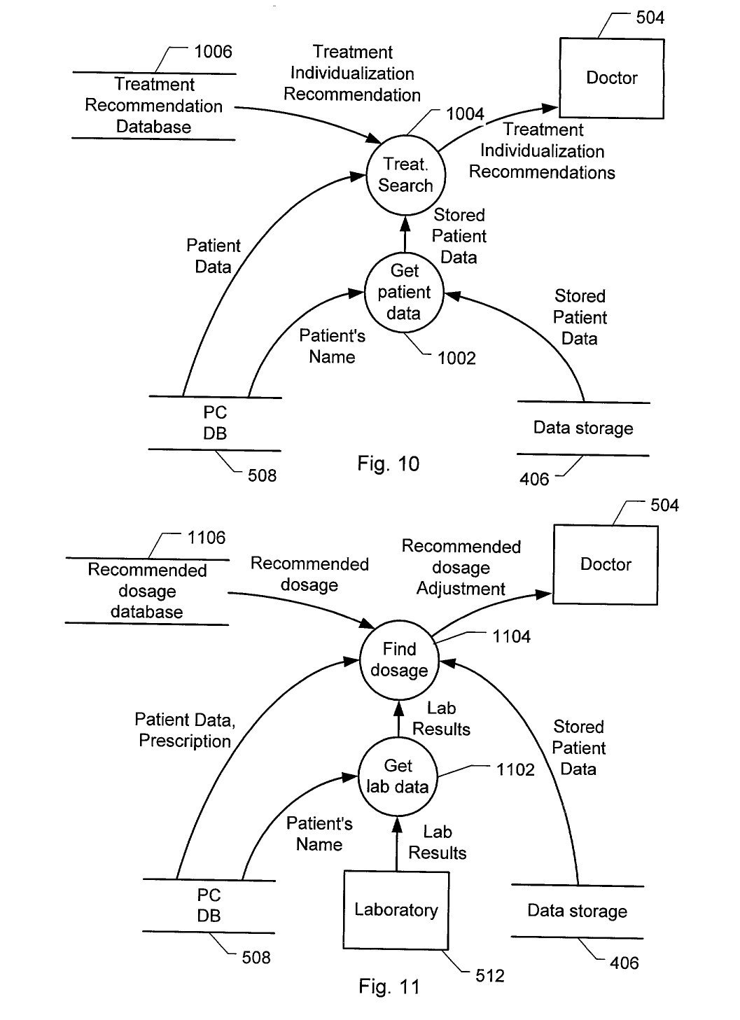

As another example, illustrated in FIG. 10, the analyze data process includes a get patient data process which accesses the data storage 406 to retrieve stored data regarding the patient. A treatment search process 1004 accesses a treatment recommendation database 1006 using a subset of the patient data and a subset of the stored patient data to retrieve a treatment individualization recommendation. The treatment individualization recommendation may include recommendations for the best treatment to fit an individual patient profile. Such recommendations may include individualized therapy based on age, gender, ethnic background, coexistent illnesses, pregnancy, drug levels, etc. For example, the drug of choice for treating high blood pressure is different in an African American patient versus a Caucasian patient, and the drug of choice for a patient with angina (chest pain from coronary heart disease) and high blood pressure is different than that for a patient with angina and smoking related chronic lung disease. These factors would be considered by the treatment search process 1004 in producing the treatment individualization recommendations. The treatment recommendation database 1006 may be a single database or multiple databases.

As another example, illustrated in FIG. 11, the analyze data process includes a get lab data process 1102 that uses a subset of the patient data to acquire laboratory results from the laboratory 512. A find dosage process 1104 uses the lab results, a subset of the patient data, the prescription and data regarding the patient stored on the data storage 406 to access a recommended dosage database 1106 to produce a recommended dosage for the prescription. The dosage may be adjusted based on age, gender, pregnancy, drug levels, coexistent medical conditions and other factors. The recommended dosage database 1106 may be a single database or multiple databases.

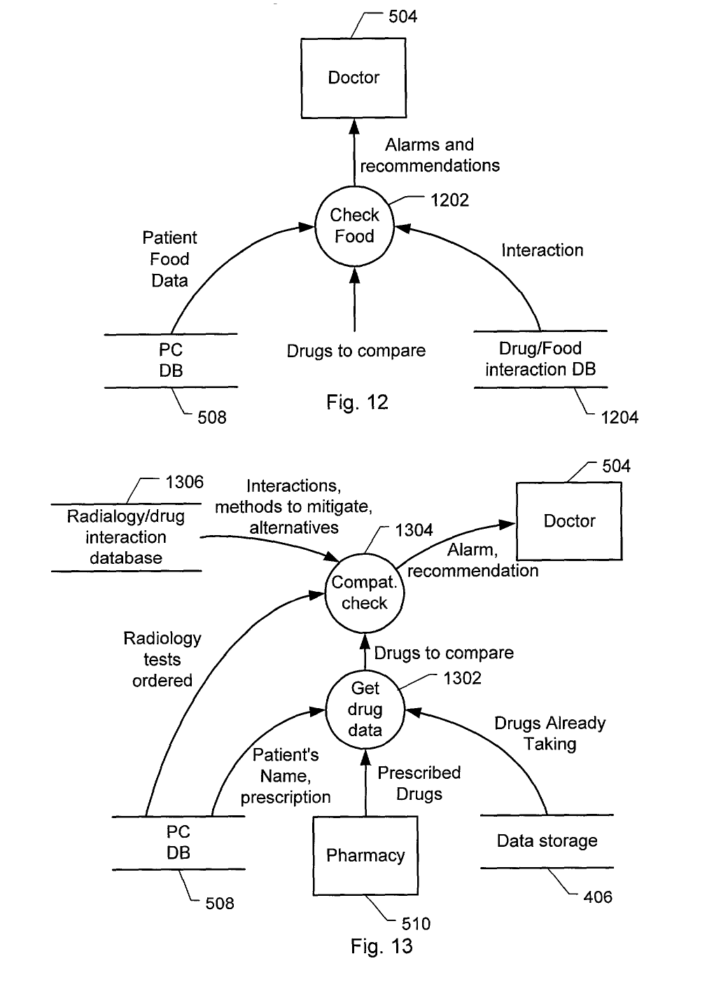

As another example, illustrated in FIG. 12, the analyze data process includes a get drug data means (not shown in FIG. 12, see FIG. 8 for an example) that uses a subset of the patient data to retrieve from a pharmacy the drugs prescribed for the patient and from the data storage means an identification of other drugs that the patient is taking. An interaction checking process 1202 accesses a drug/food interaction database 1204 with (a) the drugs prescribed for the patient, (b) the other drugs that the patient is taking, (c) the prescription and (d) the foods the patient eats, to produce an alarm if there is an indication of an interaction. For example, a high fiber (i.e. bran) diet decreases the absorption of Digoxin by 25 percent. The interaction checking process 1202 may include a recommendation process for recommending a drug that will not have an interaction. The drug/food interaction database 1204 may be a single database or multiple databases.

As another example, illustrated in FIG. 13, the analyze data process includes a get drug data process 1302 that uses a subset of the patient data to retrieve from the pharmacy 510 the drugs prescribed for the patient and from the data storage 406 an identification of other drugs that the patient is taking. An X-ray compatibility checking process 1304 accesses a radiology/drug interaction database 1306 with (a) the drugs prescribed for the patient, (b) the other drugs that the patient is taking, (c) the prescription and (d) the radiology tests from the treatment plan, to produce an alarm if there is an indication of an interaction. As an example of a radiology/drug interaction that the analyze data process is designed to detect, metformnin, a commonly used drug for treating diabetes, should be discontinued about a week before initiating an X-ray procedure involving an iodine-containing contrast. The radiology/drug interaction database 1302 may be a single database or multiple databases.

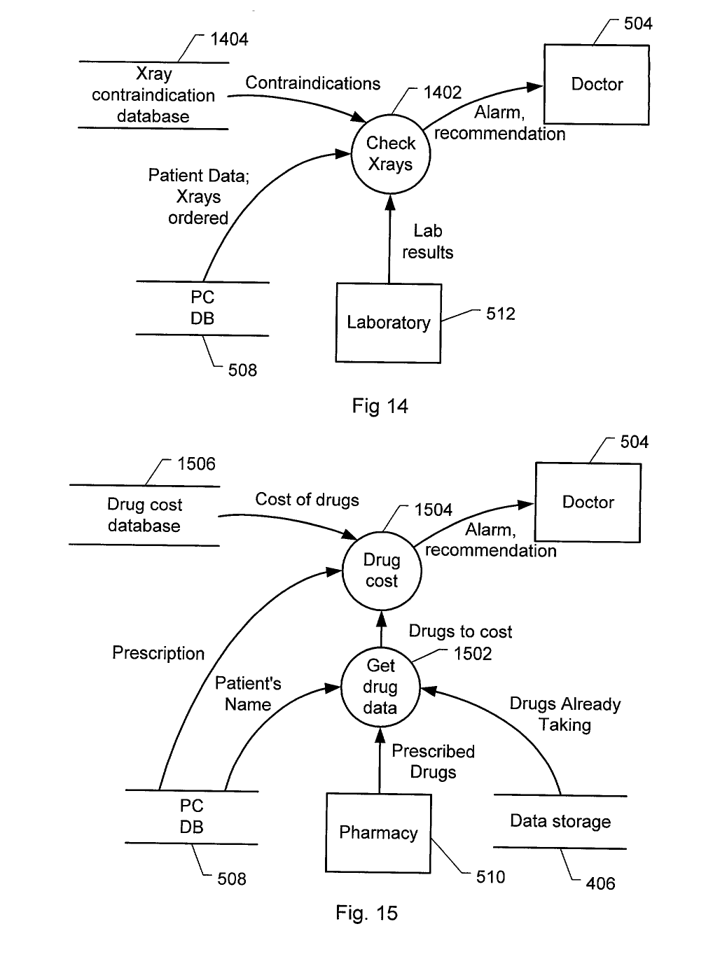

As another example, illustrated in FIG. 14, the analyze data process includes a check X-rays process 1402 that uses a subset of the patient data to acquire laboratory results from a laboratory 512 and accesses an X-ray contraindication database 1404 with the laboratory results and the order for X-rays to produce a contraindication and to process the contraindication to produce an alarm. For example, abnormal kidney function tests would contraindicate X-ray procedures with an iodine-containing contrast. The check X-rays process 1402 may also process the contraindication to produce a recommendation. The X-ray contraindication database 1404 may be a single database or multiple databases.

As another example, illustrated in FIG. 15, the analyze data process includes a get drug data process 1502 that uses a subset of the patient data to retrieve from a pharmacy 510 the drugs prescribed for the patient and from the data storage 406 an identification of other drugs that the patient is taking. A drug cost process 1504 accesses a drug cost database 1506 with (a) the drugs prescribed for the patient, (b) the other drugs that the patient is taking, and (c) the prescription, to produce an alarm if there is an indication that the patient is spending more on drugs than is necessary and to make a recommendation for a lower cost drug. The drug cost database 1506 may be a single database or multiple databases.

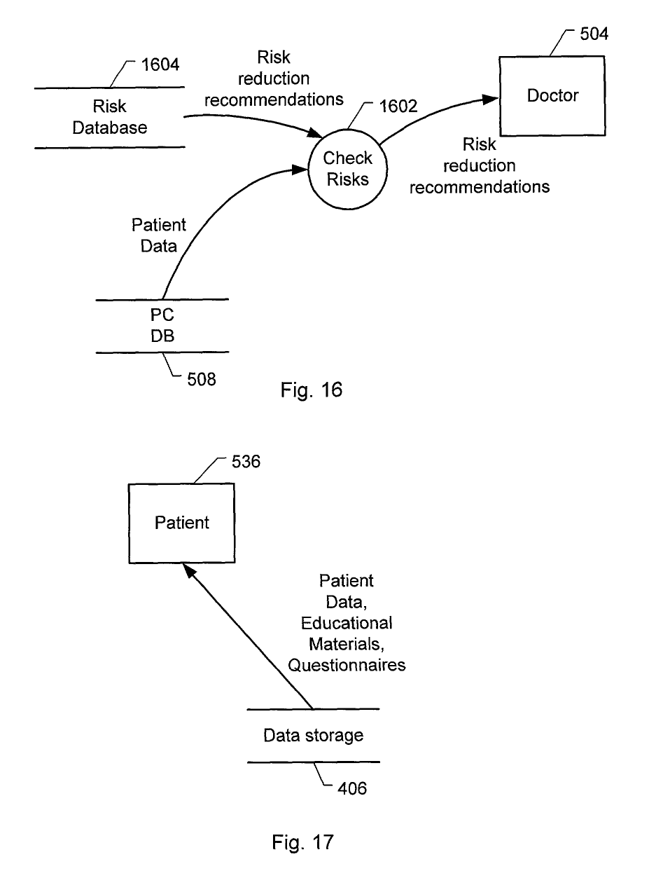

As another example, illustrated in FIG. 16, the analyze data process includes a check risks process 1602 that uses a subset of the patient data to access a risk database 1604 to produce a risk reduction recommendation for the patient. The risk reduction recommendation includes recommendations to reduce the risk of various diseases in high risk individuals by using diet, exercise, stress reduction, medications or surgical procedures. In addition, the risk reduction recommendation may include a recommendation for routine risk reduction procedures, such as a mammogram, cholesterol screening and immunizations. An example is a vigorous exercise program for young girls several years before puberty in families with high risk for breast cancer. Such a program can reduce the risk of breast cancer up to 30%. Another example would be prophylactic removal of the ovaries after child bearing is completed in women who have two or more first-degree relatives with ovarian cancer. The risk database 1604 may be a single database or multiple databases.

The system also provides a patient 536 limited access to the information stored in the data storage 406, as shown in FIG. 5. Through this access, the patient 536 can review the information stored by the doctor 504 or other staff member regarding the patient 536, as shown in FIG. 17. Further, the data storage 406 includes tools designed to educate the patient 536 and to elicit further information from the patient 536 that will be useful in treating the patient 536 and in providing risk counseling to the patient 536. The patient may take this information and request a second opinion from the system to compare with the diagnosis and treatment plan offered by the patient's physician.

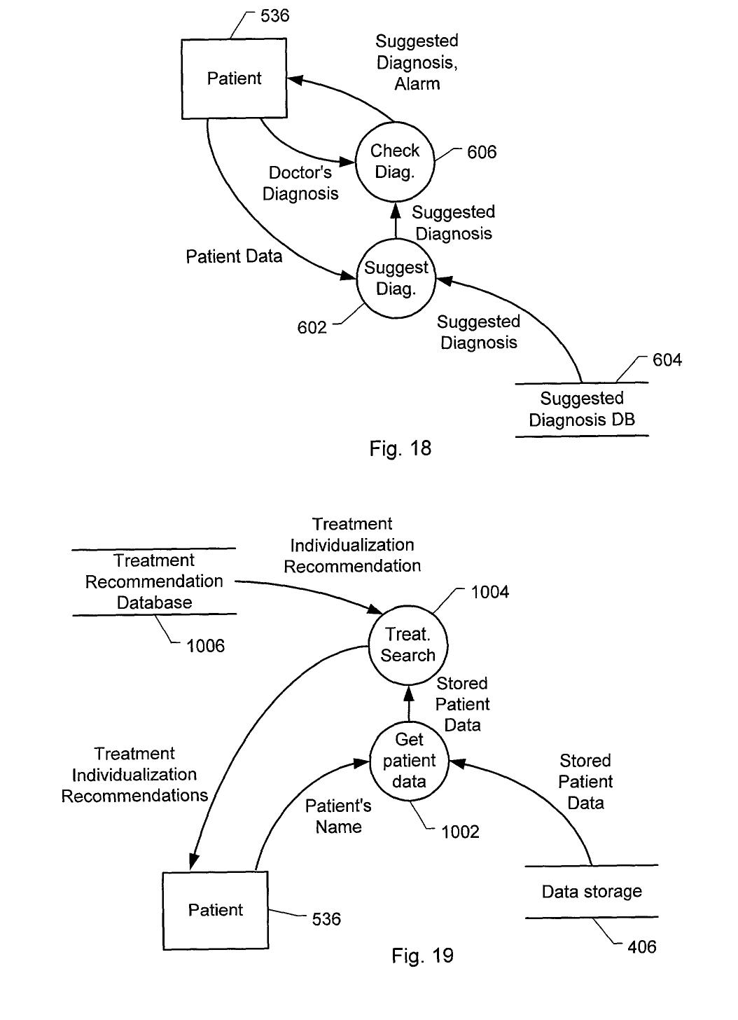

Further, through the system the patient 536 has access to many of the error-reduction tools that are available to the doctor, as illustrated in FIGS. 18-22. In FIG. 18, the patient 536 submits patient data to the suggest diagnosis process 602 that was discussed above with respect to FIG. 6. The suggest diagnosis process 602 produces a suggested diagnosis which the check diagnosis process 606 compares to the doctor's diagnosis provided by the patient 536. The patient 536 is provided with any alarms generated by the check diagnosis process 606 and the suggested diagnosis.

In FIG. 19, the patient 536 submits his or her name to the get patient data process 1002 discussed above in the discussion of FIG. 10, which retrieves from the data storage 406 data stored about the patient. The treatment search process 1004 accesses the treatment recommendation database 1006 using a subset of the stored patient data to produce a treatment individualization recommendation which is provided to the patient 536.

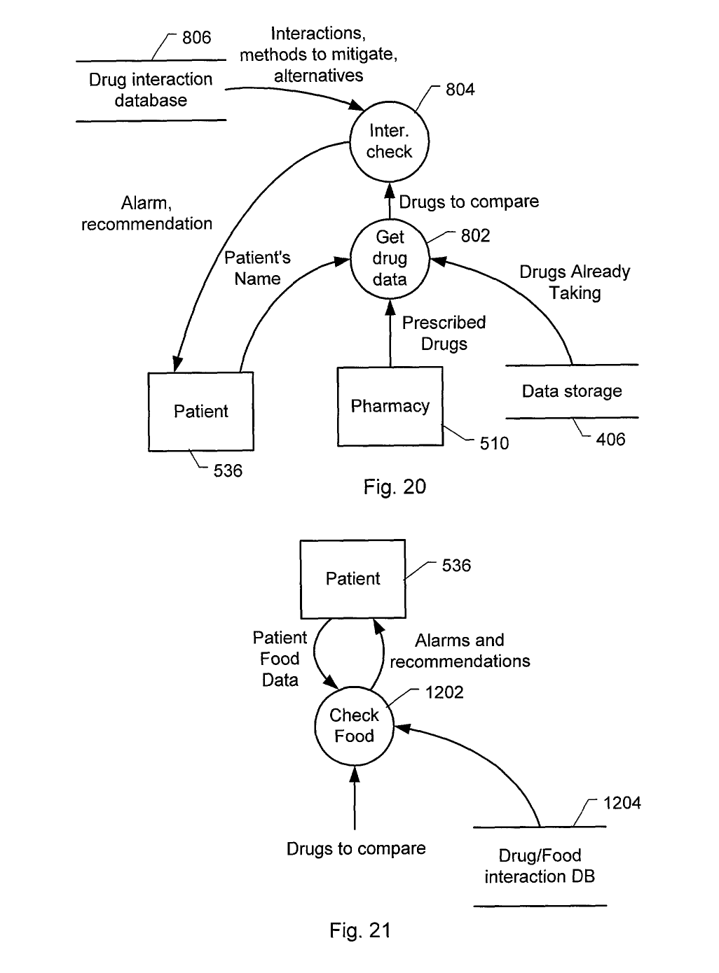

In FIG. 20, the patient 536 submits his or her name to the get drug data process 802, discussed above in the discussion of FIG. 8, which retrieves a list of drugs prescribed for the patient from the pharmacy 510 and a list of drugs that the patient is already taking from the data storage 406. An interaction check process 804 accesses a drug interaction database 806 with the list of drugs prescribed for the patient and the list of drugs that the patient is already taking and provides to the patient 536 alarms and recommendations concerning interactions between those drugs. The patient can also submit other drugs for consideration by the interaction check process 804.

In FIG. 21, the patient 536 submits a list of foods that the patient 536 eats to a check food process 1202 which also receives a list of drugs to compare compiled in the same ways as described in the description of FIG. 20. The check food process 1202 uses this information to access a drug/food interaction database 1204 and provides the patient 536 with any resulting alarms and recommendations.

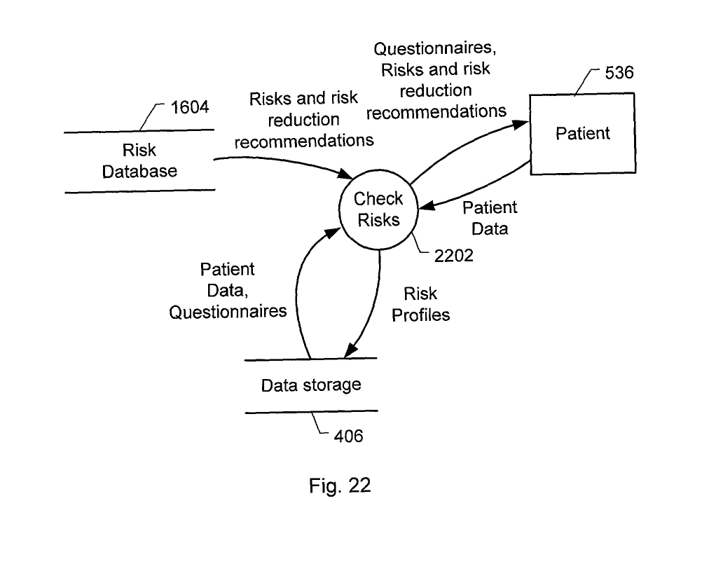

In FIG. 22, the patient provides patient data to a check risks process 2202, which is different from the check risks process 1602 discussed above in the discussion of FIG. 16 in that it retrieves from the data storage questionnaires designed to elicit risk measuring information from the patient 536. The check risks process 2202 presents the questionnaires to the patient 536 and receives the information provided by the patient 536. It then uses this information, along with other information about the patient 536 that it retrieves from the data storage 406 to access the risk database 1604. The check risks process 2202 then provides any resulting alarms and recommendations to the patient 536.

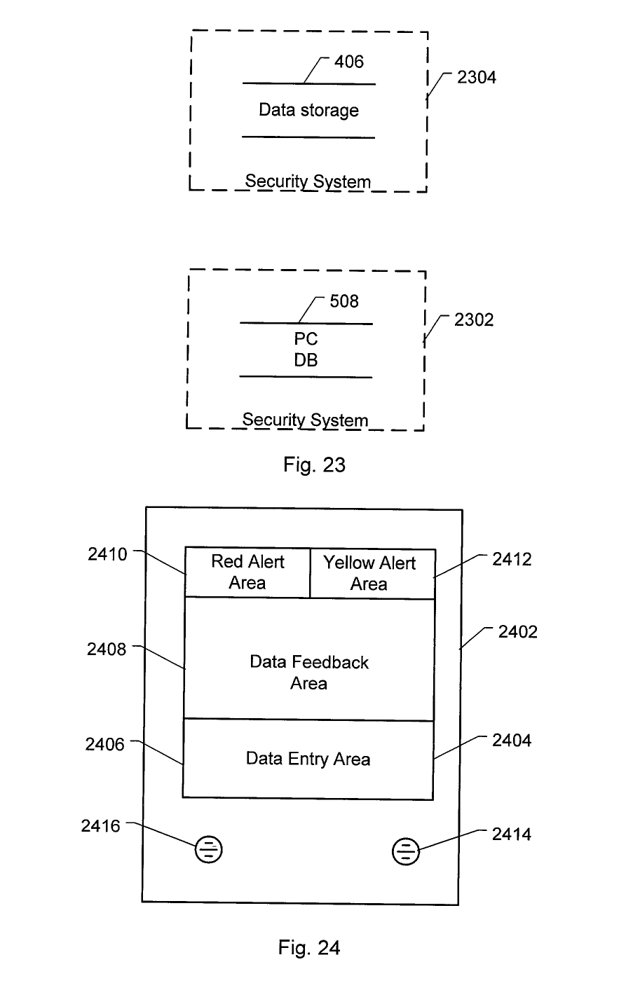

Both the PC database and the data storage 508 are protected by respective security systems 2302 and 2304, as shown in FIG. 23.

In one embodiment, the personal communicator 2402, illustrated in FIG. 24, includes a display 2404. The display 2404 is divided into a data entry area 2406, a data feedback area 2408, a red alert area 2410 and a yellow alert area 2412. The data entry area 2406 provides an area where the doctor can enter information with, for example, a stylus. The data feedback area 2408 provides an area where data, such as alarms and advice, can be displayed to the doctor. The red alert area 2410 provides an area where alarms regarding the potential for major adverse effect are displayed. The yellow alert area 2412 provides an area where alarms regarding the potential for a minor effect or need for closer monitoring are displayed.

The personal communicator 2402 may also include a microphone 2414 through which the personal communicator 2402 may receive spoken information, data or commands. The personal communicator 2402 may include voice recognition software to facilitate the entry of information, data or commands. The personal communicator 2402 also includes a speaker 2416 through which sounds, including recorded vocal information or sounds, may be played.

The data stored on the data storage 406 may include all or part of one or more of the following databases:

the suggested diagnosis database;

the standard diagnostic criteria database;

the drug interaction database;

the treatment protocol database;

the treatment recommendation database;

the recommended dosage database;

the radiology/drug interaction database;

the X-ray contraindication database;

the drug cost database; and

the risk database.

The data accessible to the doctor or the patient via the Internet may include all or part of one or more of the following:

the suggested diagnosis database;

the standard diagnostic criteria database;

the drug interaction database;

the treatment protocol database;

the treatment recommendation database;

the recommended dosage database;

the radiology/drug interaction database;

the X-ray contraindication database;

the drug cost database; and

the risk database.

The foregoing discussion includes references to processes. In a preferred embodiment, the processes are performed by software operating on the personal communicator 408 or the computer processor 404. The software can be written in machine language or assembly language or a higher order language such as C++. Some or all of the processes may be accomplished, in whole or in part, by hardware.

Further, to the extent the processes are performed by software, the software may reside on any available data storage device and may execute on any available computer processor. For example, in the preferred embodiment, the collect data process 506 executes on a processor within the personal communicator 408 using software stored on the personal communicator 408 and the analyze data process 502 executes on the computer processor 404 using software stored on the data storage 404. In other embodiments, the collect data process 506 may execute on the computer processor 404 using software stored on the data storage 404 and the analyze data process 502 may execute on a processor within the personal communicator 408 using software stored on the personal communicator 408. In still another embodiment, the processes may execute on more than one processor and may use data stored in more than one data store. Further, the processes may execute on processes available over a network or over the Internet.

The foregoing describes preferred embodiments of the invention and is given by way of example only. The invention is not limited to any of the specific features described herein, but includes all variations thereof within the scope of the appended claims.

What is claimed is:

1. A computer system for assisting a physician comprising
computer processor means for processing data;
data storage means for storing data on a storage medium;
first means for processing data regarding a patient, a diagnosis regarding the patient, and a treatment plan for the patient and for using such data to (a) generate alarms if the diagnosis or treatment plan is inappropriate and to (b) provide advice regarding the diagnosis and treatment plan;
second means for processing data regarding the alarms and advice and for using such data to communicate the alarms and advice to the physician;
third means for processing data regarding the treatment plan and using such data to implement the treatment plan; and
fourth means for processing data regarding the patient, the diagnosis regarding the patient, and the treatment plan, and storing such data on the data storage means.

2. The computer system of claim 1 wherein the first means for processing data comprises
a suggest diagnosis means for processing data using a subset of the patient data to access a suggested diagnosis database to retrieve a suggested diagnosis; and
a check diagnosis means for processing data for comparing the diagnosis to the suggested diagnosis and for generating an alarm if there is a substantial difference.

3. The computer system of claim 1 wherein the first means for processing data comprises
a find standard diagnostic criteria means for processing data using a subset of the diagnosis to access a standard diagnosis criteria database to produce a standard diagnosis criteria.

1. A computer system for assisting a physician comprising
computer processor means for processing data;
data storage means for storing data on a storage medium;
first means for processing data regarding a patient, a diagnosis regarding the patient, and a treatment plan for the patient and for using such data to (a) generate alarms if the diagnosis or treatment plan is inappropriate and to (b) provide advice regarding the diagnosis and treatment plan;
second means for processing data regarding the alarms and advice and for using such data to communicate the alarms and advice to the physician;
third means for processing data regarding the treatment plan and using such data to implement the treatment plan; and
fourth means for processing data regarding the patient, the diagnosis regarding the patient, and the treatment plan, and storing such data on the data storage means.

2. The computer system of claim 1 wherein the first means for processing data comprises
a suggest diagnosis means for processing data using a subset of the patient data to access a suggested diagnosis database to retrieve a suggested diagnosis; and
a check diagnosis means for processing data for comparing the diagnosis to the suggested diagnosis and for generating an alarm if there is a substantial difference.

3. The computer system of claim 1 wherein the first means for processing data comprises
a find standard diagnostic criteria means for processing data using a subset of the diagnosis to access a standard diagnosis criteria database to produce a standard diagnosis criteria.

4. The computer system of claim 1 wherein the treatment plan includes a prescription and the first means for processing data comprises
a get drug data means for processing data using a subset of the patient data to retrieve from a pharmacy the drugs prescribed for the patient and from the data storage means an identification of other drugs that the patient is taking; and
an interaction checking means for processing data to access a drug interaction database with (a) the drugs prescribed for the patient, (b) the other drugs that the patient is taking, and (c) the prescription, to produce an alarm if there is an indication of an interaction.

5. The computer system of claim 4 wherein the interaction checking means comprises
mitigating means for suggesting methods to mitigate the interaction; and
alternative recommendation means for suggesting alternative drugs with no interaction.

6. The computer system of claim 1 wherein the first means for processing data comprises
a get patient data means for processing data for accessing the data storage means to retrieve stored data regarding the patient;
a find treatment means for processing data for accessing a treatment protocol database using a subset of the patient data and a subset of the stored patient data to retrieve a recommended treatment protocol.

7. The computer system of claim 1 wherein the first means for processing data comprises
a get patient data means for processing data for accessing the data storage means to retrieve stored data regarding the patient;
a treatment search means for processing data for accessing a treatment recommendation database using a subset of the patient data and a subset of the stored patient data to retrieve a treatment individualization recommendation.

8. The computer system of claim 1 wherein the diagnosis comprises a prescription and the first means for processing data comprises
a get lab data means for processing data using a subset of the patient data to acquire laboratory results from a laboratory;
a find dosage means for processing data for using the lab results, a subset of the patient data, the prescription and data regarding the patient stored on the data storage means to access a recommended dosage database to produce a recommended dosage for the prescription.

9. The computer system of claim 1 wherein the patient data comprises foods the patient eats, the treatment plan comprises a prescription and the first means for processing data comprises
a get drug data means for processing data using a subset of the patient data to retrieve from a pharmacy the drugs prescribed for the patient and from the data storage means an identification of other drugs that the patient is taking; and
an interaction checking means for processing data to access a drug/food interaction database with (a) the drugs prescribed for the patient, (b) the other drugs that the patient is taking, (c) the prescription and (d) the foods the patient eats, to produce an alarm if there is an indication of an interaction.

10. The computer system of claim 9 wherein the interaction checking means includes a recommendation means for recommending a drug that will not have an interaction.

11. The computer system of claim 1 wherein the treatment plan comprises a prescription and radiology tests and the first means for processing data comprises
a get drug data means for processing data using a subset of the patient data to retrieve from a pharmacy the drugs prescribed for the patient and from the data storage means an identification of other drugs that the patient is taking; and
an X-ray compatibility checking means for processing data to access a radiology/drug interaction database with (a) the drugs prescribed for the patient, (b) the other drugs that the patient is taking, (c) the prescription and (d) the radiology tests from the treatment plan, to produce an alarm if there is an indication of an interaction.

12. The computer system of claim 1 wherein the treatment plan comprises an order for X-rays and the first means for processing data comprises
a check X-rays means for processing data using a subset of the patient data to acquire laboratory results from a laboratory and for accessing an X-ray contraindication database with the laboratory results and the order for X-rays to produce a contraindication and to process the contraindication to produce an alarm.

13. The computer system of claim 12 wherein the check X-rays means for processing data also processes the contraindication to produce a recommendation.

14. The computer system of claim 1 wherein the treatment plan comprises a prescription and the first means for processing data comprises
a get drug data means for processing data using a subset of the patient data to retrieve from a pharmacy the drugs prescribed for the patient and from the data storage means an identification of other drugs that the patient is taking; and
a drug cost means for processing data to access a drug cost database with (a) the drugs prescribed for the patient, (b) the other drugs that the patient is taking, and (c) the prescription, to produce an alarm if there is an indication that the patient is spending more on drugs than is necessary and to make a recommendation for a lower cost drug.

15. The computer system of claim 1 wherein the first means for processing data comprises
a check risks means for processing data using a subset of the patient data to access a risk data base to produce a risk reduction recommendation for the patient.

16. The computer system of claim 1 further comprising
a fifth means for processing data through which a patient has access to data regarding the patient stored on the storage means.

17. The computer system of claim 16 wherein
the patient has access to the first means.

18. The computer system of claim 1 wherein
the third means comprises a personal communicator.

19. The computer system of claim 18 wherein the personal communicator comprises
a personal digital assistant.

20. The computer system of claim 18 wherein the personal communicator comprises
a personal computer.

21. The computer system of claim 18 wherein the personal communicator comprises
a PC database for storing patient data.

22. The computer system of claim 21 wherein
the PC database is protected by a first security system; and
the data storage means is protected by a second security system.

23. The computer system of claim 18 wherein the personal communicator comprises
a display, the display comprising
a red alert area, where alarms regarding the potential for a major adverse effect are displayed; and
a yellow alert area, where alarms regarding the potential for a minor effect or need for closer monitoring are displayed.

24. The computer system of claim 18 wherein
the third means communicates with the computer processor means through a communications media.

25. The computer system of claim 24 wherein
the communications media is a wireless communications media.

26. The computer system of claim 25 wherein
the wireless communications media comprises one or more of the following types of media: RF, optical or infrared.

27. The computer system of claim 24 wherein
the communications media is a wired communications media.

28. The computer system of claim 27 wherein
the wired communications media comprises one or more of the following types of media: twisted pair cable, coax cable, or optical cable.

29. The computer system of claim 1 wherein the data stored on the data storage means comprises one or more of the following:
a suggested diagnosis database;
a standard diagnostic criteria database;
a drug interaction database;
a treatment protocol database;
a treatment recommendation database;
a recommended dosage database;
a radiology/drug interaction database;
an X-ray contraindication database;
a drug cost database; and
a risk database.

30. The computer system of claim 1 wherein the first means has access to one or more of the following via the Internet:
a suggested diagnosis database;
a standard diagnostic criteria database;
a drug interaction database;
a treatment protocol database;
a treatment recommendation database;
a recommended dosage database;
a radiology/drug interaction database;
an X-ray contraindication database;
a drug cost database; and
a risk database.

31. The computer system of claim 1 wherein the third means comprises
an ICD determination means for processing a subset of the patient data, a subset of the diagnosis and a subset of the treatment plan to determine an ICD.

32. The computer system of claim 1 wherein the treatment plan comprises a prescription and an order, the patient data comprises an ICD, and the third means comprises one or more of the following:
a print prescription means for processing data for using the prescription to print a prescription form;
an inform pharmacy means for processing data for using the prescription to inform a pharmacy of the prescription;
a store data means for processing data to store patient data on a hospital computer;
an enter order means for processing data to enter the order in a physician order entry system;
a save ICD means for processing data to save the ICD in a business office.

33. A computerized method for providing assistance to a physician who has gathered data from a patient, made a diagnosis, and prepared a treatment plan, the treatment plan comprising one or more of the following: (a) a prescription, (b) radiology tests, (c) X-rays, and (d) a treatment protocol, the method being accomplished using a personal communicator, a computer processor coupled to the personal communicator through a communications media, a data storage media coupled to the computer processor, and Internet resources coupled to the computer processor, the method comprising
entering patient data, a diagnosis and a treatment plan into the personal communicator;
selecting, through the personal communicator, one or more of the following actions:
implementing the treatment plan;
consulting resources to produce an alarm and a recommendation, displaying the alarm and the recommendation, and allowing the physician to revise the diagnosis and treatment plan based on the alarm and the recommendation.

34. The method of claim 33 wherein implementing the treatment plan comprises one or more of the following
printing a prescription;
informing a pharmacy of the prescription;
storing the patient data, the diagnosis, and the treatment plan on a hospital computer;
entering an order into a physician order entry system; and
saving an ICD in a business office.

35. The method of claim 33 wherein consulting resources to produce an alarm and a recommendation comprises
offering the physician consultation choices;
communicating a subset of the patient data, the diagnosis, the treatment plan and the consultation choice to the computer processor;
processing the patient data, the diagnosis and the treatment plan in accordance with the consultation choice to produce alarms and advice;
communicating the alarms and advice to the personal communicator.

36. The method of claim 35 wherein processing the patient data, the diagnosis and the treatment plan in accordance with the consultation choice to produce alarms and advice comprises performing one or more of the following actions:
checking the accuracy of the diagnosis;
reviewing standard diagnostic criteria;
checking the appropriateness of prescribed medication;
reviewing recommended treatment protocols;
reviewing individualization recommendations;
recommending dose adjustments;
checking for adverse medication interactions;
checking for adverse food interactions;
checking for adverse medication/radiology interactions;
checking for X-ray contraindications;
checking the cost of prescribed medications;
transferring clinical notes to medical records;
reviewing standard immunization protocols; and
recommending routine screening measures.

37. The method of claim 34 further comprising
accepting clinical notes regarding the patient.

38. The method of claim 37 wherein accepting the clinical notes comprises recording a spoken rendering of the clinical notes.
